(19) United States
(12) Patent Application Publication
(10) Pub. No.: US 2021/0264482 A1
(43) Pub. Date: Aug. 26, 2021

(54) SYSTEM AND METHOD FOR REVIEWING A PRODUCT OR SERVICE

(71) Applicant: Debasis Chatterji, Hyderabad (IN)

(72) Inventor: Debasis Chatterji, Hyderabad (IN)

(73) Assignee: Hybrid Mind India Private Limited, Hyderabad (IN)

(21) Appl. No.: 17/170,968

(22) Filed: Feb. 9, 2021

(30) Foreign Application Priority Data
Feb. 25, 2020 (IN) 202041007914

(51) Int. Cl. G06Q 30/02; G06Q 30/06; G06F 16/2457; G06F 16/2455

(52) U.S. Cl. CPC G06Q 30/0282; G06F 16/24556; G06F 16/24578; G06Q 30/0631

(57) ABSTRACT

A system for reviewing a product or service is provided. The system includes a review receiving module receives one or more selections of positive parameters and negative parameters about the product, from users. A review quotient computing module computes an aggregate value for each of the positive parameters and each of the negative parameters using one or more received selections; ranks the positive parameters and the negative parameters based on the aggregate value computed for each of the positive parameters and each of the negative parameters; computes a positive aggregate value and a negative aggregate value based on top-ranked positive parameters and top-ranked negative parameters, respectively; determines a review quotient by computing a ratio between the positive aggregate value and the negative aggregate value; and compares the review quotient determined with a predefined threshold value. A recommendation module recommends new users to purchase the product based on the review quotient.

### CROSS REFERENCE TO RELATED APPLICATION

The present application claims the benefit of Indian patent numbered 351875 and its application number 202041007914 for “A SYSTEM AND METHOD FOR REVIEWING A PRODUCT OR SERVICE” filed on Feb. 25, 2020, the contents of which is hereby incorporated by reference. The specification of the above referenced patent application is incorporated herein by reference in its entirety.

### BACKGROUND OF THE INVENTION

### A. Technical Field

Embodiments of the present disclosure relate to collecting feedback, and more particularly to, a system and a method for reviewing a product or a service.

### B. Description of Related Art

Today, users research a product or a service before purchasing it, in addition to the resource from where the users are purchasing the product. Conventionally, the users view the reviews and ratings of the product and/or services provided by users who have already used the product. in order to purchase a product, the user may go through numerous reviews and still be confused if the product or a service is good to be purchased. The user having to go through numerous reviews is a tedious process and after going through numerous reviews, if the confusion still persists, then the user may not purchase the product/service or may choose to opt for a different brand that provides a similar product/service. Due to indecisiveness based on the numerous reviews, the seller loses out on selling the product/service.

In addition to the aforementioned issue, the feedback received from users is long, verbose, time-consuming to write and read. There is no universal, product/service agnostic, simple, pre-defined multilingual, attribute-based, pictorial feedback system and no distinct product/service recommendation system also which can directly guide the customer in clear terms whether to buy the product/service or not. Currently, the star-rated system only qualifies the popular opinion of a product/service but fails to qualify two products/services—with the same rating and similar price range, as to which of the two products/services is superior or inferior. Similar logic applies for a variety of services also in which only criteria of service attribute may vary from case-to-case basis.

Therefore, there is a requirement for a system that can overcome the aforementioned issues.

### SUMMARY OF THE INVENTION

In accordance with one embodiment of the disclosure, a system for reviewing a product is provided. The system includes a review receiving module operable by the one or more processors, wherein the review receiving module is configured to receive one or more selections of a plurality of positive parameters and a plurality of negative parameters about the product, from one or more users.

The system includes a review quotient computing module operable by the one or more processors, wherein the review quotient computing module is configured to compute an aggregate value for each of the plurality of positive parameters and each of the plurality of negative parameters using one or more received selections from the review receiving module; rank the plurality of positive parameters and the plurality of negative parameters based on the aggregate value computed for each of the plurality of positive parameters and each of the plurality of negative parameters; compute a positive aggregate value and a negative aggregate value based on one or more top-ranked plurality of positive parameters and one or more top-ranked plurality of negative parameters, respectively; determine a review quotient by computing a ratio between the positive aggregate value and the negative aggregate value; and compare the review quotient determined with a predefined threshold value. The system also includes a recommendation module operable by the one or more processors, wherein the recommendation module is configured to recommend one or more new users to purchase the product based on the review quotient determined. Further, the system also includes a verification module operable by the one or more processors, wherein the verification module is configured to prevent the one or more users from selecting different set of the multiple positive parameters and the multiple negative parameters.

In accordance with another embodiment of the disclosure, a method for reviewing a product is provided. The method includes receiving one or more selections of a plurality of positive parameters and a plurality of negative parameters about the product, from one or more users; computing an aggregate value for each of the plurality of positive parameters and each of the plurality of negative parameters using one or more received selections from the review receiving module; ranking the plurality of positive parameters and the plurality of negative parameters based on the aggregate value computed for each of the plurality of positive parameters and each of the plurality of negative parameters; computing a positive aggregate value and a negative aggregate value based on corresponding one or more top-ranked plurality of positive parameters and one or more top-ranked plurality of negative parameters; determining a review quotient by computing a ratio between the positive aggregate value and the negative aggregate value; comparing the review quotient determined with a predefined threshold value; and recommending the one or more new users to purchase the product based on the review quotient determined.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 illustrates a block diagram of a system for reviewing a product in accordance with an embodiment of the present disclosure;

FIG. 2 illustrates a block diagram of an exemplary embodiment of FIG. 1 in accordance with an embodiment of the present disclosure;

FIG. 3 illustrates a block diagram representation of a processing subsystem located on a remote server in accordance with an embodiment of the present disclosure; and

FIG. 4 illustrates a flow chart representing steps involved in a method for FIG. 1 in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF EMBODIMENTS

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

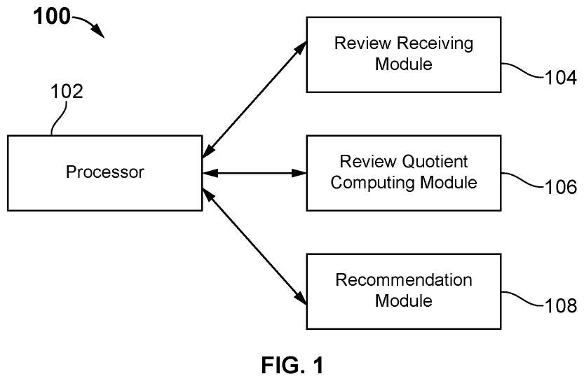

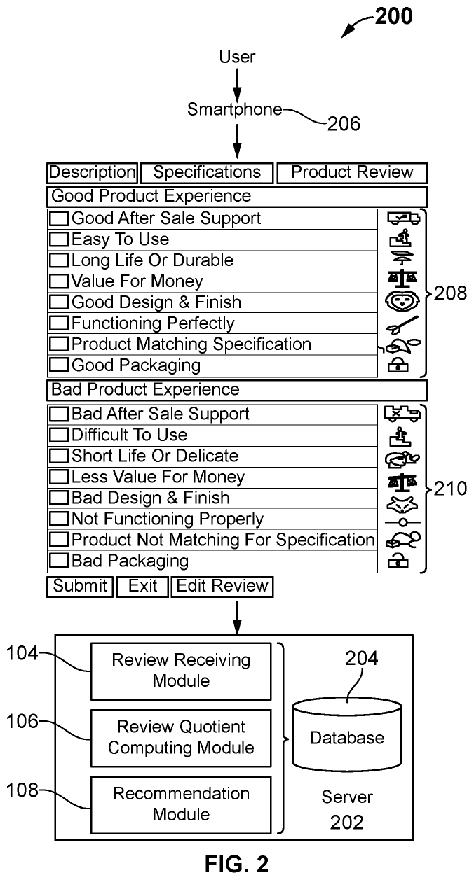

Turning to FIGS. 1 and 2, FIG. 1 illustrates a block diagram of a system 100 for reviewing a product in accordance with an embodiment of the present disclosure. FIG. 2 illustrates a block diagram of an exemplary embodiment 200 of FIG. 1 in accordance with an embodiment of the present disclosure. The system 100 includes one or more processors 102 which operate a review receiving module 104, a review quotient computing module 106 and a recommendation module 108. The review receiving module 104 is configured to receive one or more selections of multiple positive parameters 208 and multiple negative parameters 210 about the product from one or more users, via a computing device, including but not limited to a smartphone and a laptop.

In one embodiment, the product is being sold on an e-commerce platform, wherein the product, upon purchase by the one or more users, receives the one or more selections representing feedback on good qualities and bad qualities of the product. For the one or more users to provide feedback on the product, the multiple positive parameters 208 and the multiple negative parameters 210 are displayed to the one or more users. The one or more users are enabled to select one or more positive parameters 208 and/or one or more negative parameters. The review receiving module 104, upon receiving the one or more selections from the one or more users, passes one or more received selections to the review quotient computing module 106. In one embodiment, the e-commerce platform provides the one or more users with an option to chooses from one or more languages for a better understanding of the product.

The review quotient computing module 106 receives the one or more selections from the review receiving module 104 and computes an aggregate value for each of the multiple positive parameters 208 and each of the multiple negative parameters 210 by adding each count of corresponding each of the multiple positive parameters 208 and the multiple negative parameters 210. Upon computing the aggregate value, the review quotient computing module 106 then ranks the multiple positive parameters 208 based on the aggregate value computed for corresponding multiple positive parameters 208. Similarly, the multiple negative parameters 210 are ranked based on the aggregate value computed for corresponding multiple negative parameters 210.

Once the multiple positive parameters 208 and the multiple negative parameters 210 are ranked, the review quotient computing module 106 computes a positive aggregate value and a negative aggregate value. The positive aggregate value is computed based on one or more top-ranked positive parameters. Similarly, the negative aggregate value is computed based on one or more top-ranked negative parameters. The review quotient computing module 106 is then configured to determine a review quotient by dividing the positive aggregate value with the negative aggregate value, thereby computing a ratio representing the review quotient. The review quotient is compared with a predefined threshold value. In one embodiment, the review quotient may also be termed as “VAROSA SCORE”. In one embodiment, the predefined threshold value is 1, wherein the predefined threshold is considered as 1 when the positive aggregate value equals the negative aggregate value. The recommendation module 108 recommends one or more new users the product based on the review quotient determined. In one embodiment, upon comparison, if the review quotient determined is greater than the predefined threshold value, then the recommendation module 108 recommends the one or more new users the product to be purchased, wherein greater the review quotient, the higher are the probability and confidence of recommending the product to the one or more new users. In another embodiment, if the review quotient determined is less than the predefined threshold value, then the recommendation module 108 does not recommend the product to the one or more new users. In yet another embodiment, if the review quotient determined is equal to 1, then the recommendation module 108 does not recommend the product to the one or more new users as the it is an ambivalent case.

Further, in an embodiment, if the one or more users select a same positive parameter as a negative parameter, then the system will nullify the points provided to the positive parameter and the negative parameters. Further, in order to prevent multiple selections from a same user a captcha-based verification method is implemented. Further, a user can select from the multiple positive parameters 208 and the multiple negative parameters 210 for the product from time to time depending on the user's experience of the product over the lifecycle of the product. However, every time the user selects from the multiple positive parameters 208 and the multiple negative parameters 210, the system 100 overrides the existing points for both the multiple positive parameters 208 and the multiple negative parameters 210 with the new selections made by the user. Therefore, only one input by one user is recorded by the system for one product, thereby avoiding duplication or fake review to alter the review quotient determined.

In one exemplary embodiment, the product is being sold on an e-commerce platform. For example, an electronic product, say a camera is to be provided with feedback, wherein when a user clicks on product review of the camera. The user is displayed with multiple positive parameters 208 and multiple negative parameters 210. In one embodiment, the multiple positive parameters 208 are, including but not limited to, “good after sale support”, “easy to use”, “long life or durable”, “value for money”, “good design and finish”, functioning perfectly”, “product matching specification” and “good packaging”. In one embodiment, the multiple negative parameters 210 are, including but not limited to, “bad after sale support”, “difficult to use”, “short life or delicate”, “less value for money”, “bad design and finish”, “not functioning properly”, “product not matching for specification” and “bad packaging”.

In one embodiment, every time the one or more users select a parameter, from the multiple positive parameters 208 and the multiple negative parameters, 210, the selected parameter gets a point. Therefore, each of the aforementioned selected parameters of both the multiple positive parameters 208 and negative parameters 210 are provided with a point. Say each of the multiple positive parameters 208 and each of the multiple negative parameters 210 is already provided with points from 10 users who have previously purchased and used the product. Based on the selections provided by the 10 users, the current points for each of the multiple positive parameters 208 are:

| | |
|---|---|
| “Good after sale support”: | 2 |
| “Easy to use”: | 9 |
| “Long life or durable”: | 4 |
| “Value for Money”: | 15 |
| “Good design and finish”: | 5 |
| “Functioning perfectly”: | 7 |
| “Product matching specification”: | 6 |
| “Good packaging”: | 6 |

Similarly, the current points for each of the multiple negative parameters 210 are:

| | |
|---|---|
| “Bad after sale support”: | 9 |
| “Difficult to use”: | 2 |
| “Short life or delicate”: | 5 |
| “Less value for money”: | 0 |
| “bad design and finish”: | 7 |
| “Not functioning properly”: | 3 |
| “Product not matching for specification”: | 1 |
| “Bad packaging”: | 8 |

In one embodiment, the selections provided by the 10 users are stored in a database 204 hosted on a server 202. The user is required to provide one or more selections, via a smartphone 206, from the multiple positive parameters 208 and the multiple negative parameters 210. In one embodiment, the user is required to provide at least three selections. In one embodiment, the at least three selections provided by the user is stored in the database 204. Say, the user selects “value for money”, “functioning perfectly” and “product matching specification” from the multiple positive parameters 208. Similarly, the user selects “bad design and finish”, “bad packaging” and “bad after sale support” from the multiple negative parameters 210. In addition to the current points for each of the multiple positive parameters 208 and the multiple negative parameters 210, the points provided by the user, add a point to the “value for money”, “functioning perfectly” and “product matching specification” from the multiple positive parameters; “bad design and finish”, “bad packaging” and “bad after sale support” from the multiple negative parameters. Therefore, the review quotient computing module 106, upon computing an aggregate value for each of the multiple positive parameters 208 and each of the multiple negative parameters 210, the aggregate value for each of the multiple positive parameters 208.

| | |
|---|---|
| “Good after sale support”: | 2 |
| “Easy to use”: | 9 |
| “Long life or durable”: | 4 |
| “Value for Money”: | 16 |
| “Good design and finish”: | 5 |
| “Functioning perfectly”: | 8 |
| “Product matching specification”: | 7 |
| “Good packaging”: | 6 |

Similarly, the aggregate value for each of the multiple negative parameters 210 are:

| | |
|---|---|
| “Bad after sale support”: | 10 |
| “Difficult to use”: | 2 |
| “Short life or delicate”: | 5 |
| “Less value for money”: | 0 |
| “Bad design and finish”: | 8 |
| “Not functioning properly”: | 3 |
| “Product not matching for specification”: | 1 |
| “Bad packaging”: | 9 |

Once the aggregate value is computed for each of the multiple positive parameters 208 and each of the multiple negative parameters 210, the review quotient computing module 106 ranks the multiple positive parameters 208 and the multiple negative parameters 210.

| | |
|---|---|
| “Value for Money”: | 16 |
| “Easy to use”: | 9 |
| “Functioning perfectly”: | 8 |
| “Product matching specification”: | 7 |
| “Good packaging”: | 6 |
| “Good design and finish”: | 5 |
| “Long life or durable”: | 4 |
| “Good after sale support”: | 2 |

Similarly, the review quotient computing module 106 ranks the multiple negative parameters 210:

| | |
|---|---|
| “Bad after sale support”: | 10 |
| “Bad packaging”: | 9 |
| “Bad design and finish”: | 8 |
| “Short life or delicate”: | 5 |
| “Not functioning properly”: | 3 |
| “Difficult to use”: | 2 |
| “Product not matching for specification”: | 1 |
| “Less value for money”: | 0 |

Once the multiple positive parameters 208 and the multiple negative parameters 210 are ranked, the review quotient computing module 106 computes a positive aggregate value and a negative aggregate value. The positive aggregate value is computed by adding one or more top ranked multiple positive parameters. In one embodiment, the top three positive parameters 208 are added. Therefore, the positive aggregate value is 33 by adding “Value for Money”+“Easy to use”+“Functioning perfectly”: 16+9+8=33. Similarly, the negative aggregate value is computed by adding one or more top ranked multiple negative parameters 210. In one embodiment, the top three negative parameters 210 are added. Therefore, the negative aggregate value is “Bad after sale support”+“Bad packaging”+“Bad design and finish”: 10+9+8=27.

After determining the positive aggregate value and the negative aggregate value, the review quotient computing module 106 determines a review quotient by computing a ratio between the positive aggregate value and the negative aggregate value. Upon dividing the positive aggregate value with the negative aggregate value, the review quotient determined is 1.22. The review quotient computing module 106 compares the review quotient—1.22 with a predefined threshold value, that is, 1, thereby determining the review quotient 1.22 is greater than 1. Since the review quotient is greater than 1, the recommendation module 108 recommends the product to one or more new users.

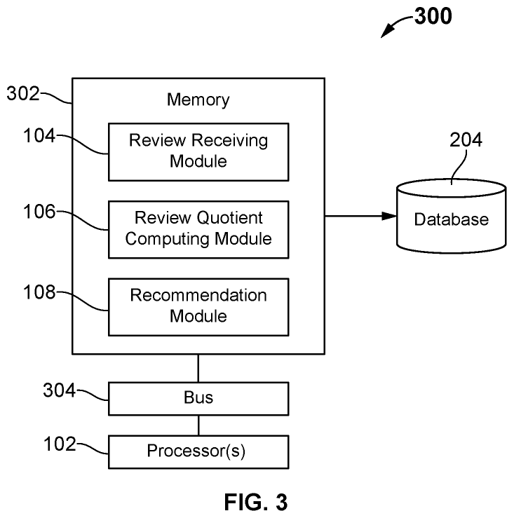

FIG. 3 illustrates a block diagram representation of a processing subsystem 300 located on a remote server in accordance with an embodiment of the present disclosure. The system includes the processor(s) 102, bus 304 and memory 302 coupled to the processor(s) 102 via the bus 304, and the database 204. The processor(s) 102, as used herein, means any type of computational circuit, such as but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof. The bus as used herein is a communication system that transfers data between components inside a computer, or between computers.

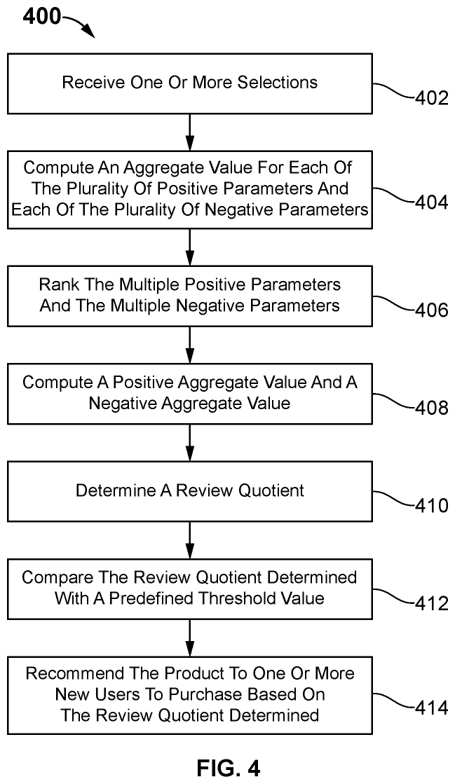

The memory 302 includes a plurality of modules stored in the form of an executable program that instructs the processor to perform the method steps illustrated in FIG. 4. The memory 302 has the following modules: the review receiving module 104, the review quotient computing module 106, and the recommendation module 108. Computer memory elements may include any suitable memory device for storing data and executable programs, such as read-only memory, random access memory, erasable programmable read-only memory, electrically erasable programmable read-only memory, hard drive, removable media drive for handling memory cards and the like. Embodiments of the present subject matter may be implemented in conjunction with program modules, including functions, procedures, data structures, and application programs, for performing tasks, or defining abstract data types or low-level hardware contexts. The executable program stored on any of the above-mentioned storage media may be executable by the processor(s) 102.

The review receiving module 104 operable by the one or more processors 102, wherein the review receiving module 104 is configured to receive one or more selections of the multiple positive parameters 208 and the multiple negative parameters 210 about the product, from one or more users. The review quotient computing module 106 operable by the one or more processors 102, wherein the review quotient computing module 106 is configured to compute an aggregate value for each of the multiple positive parameters 208 and each of the multiple negative parameters 210 using one or more received selections from the review receiving module 104; rank the multiple positive parameters 208 and the multiple negative parameters 210 based on the aggregate value computed for each of the multiple positive parameters 208 and each of the multiple negative parameters 210; compute a positive aggregate value and a negative aggregate value based on one or more top-ranked multiple positive parameters 208 and one or more top-ranked multiple negative parameters 210, respectively; determine a review quotient by computing a ratio between the positive aggregate value and the negative aggregate value; and compare the review quotient determined with a predefined threshold value. The recommendation module 108 operable by the one or more processors 102, wherein the recommendation module 108 is configured to recommend one or more new users to purchase the product based on the review quotient determined.

FIG. 4 illustrates a flow chart representing steps involved in a method 400 thereof of FIG. 1 in accordance with an embodiment of the present disclosure. The method 400 includes receiving one or more selections, in step 402. The method 400 includes receiving, by a review receiving module, the one or more selections of multiple positive parameters and multiple negative parameters about the product, from one or more users. In one embodiment, the product is being sold on an e-commerce platform, wherein the product, upon purchase by the one or more users, receives the one or more selections representing feedback on good qualities and bad qualities of the product. For the one or more users to provide feedback on the product, the multiple positive parameters, and the multiple negative parameters are displayed to the one or more users. The one or more users are enabled to select one or more positive parameters and/or one or more negative parameters. The review receiving module, upon receiving the one or more selections from the one or more users, passes one or more received selections to the review quotient computing module.

The method 400 includes computing an aggregate value for each of the multiple positive parameters and each of the multiple negative parameters, in step 404. The method 400 includes computing, by a review quotient computing module, the aggregate value for each of the multiple positive parameters and each of the multiple negative parameters using one or more received selections, from the review receiving module, by adding each count of corresponding each of the multiple positive parameters and the multiple negative parameters.

The method 400 includes ranking the multiple positive parameters and the multiple negative parameters, in step 406. The method 400 includes ranking, by the review quotient computing module, the multiple positive parameters and the multiple negative parameters based on the aggregate value computed for each of the multiple positive parameters and each of the multiple negative parameters. The method 400 includes computing a positive aggregate value and a negative aggregate value, in step 408. The method 400 includes computing, by the review quotient computing module, a positive aggregate value and a negative aggregate value based on one or more top-ranked multiple positive parameters and one or more top-ranked multiple negative parameters, respectively.

The method 400 includes determining a review quotient, in step 410. The method 400 includes determining, by the review quotient computing module, the review quotient by computing a ratio between the positive aggregate value and the negative aggregate value. The method 400 includes comparing, by the review quotient computing module, the review quotient determined with a predefined threshold value, in step 412. In one embodiment, the predefined threshold value is 1. The method 400 includes recommending, by a recommendation module, the product to one or more new users to purchase based on the review quotient determined, in step 414. In one embodiment, if the review quotient is greater than the predefined threshold value, then the recommendation module recommends the product to the one or more new users. Further, the method 400 also includes storing one or more received selections, from the one or more users, in a database hosted on a server.

The system and method for reviewing a product, as disclosed herein, provides various advantages, including but not limited to, helps customers avoid long verbose, multilingual feedback for the product provided by customers who have purchased the product; and also helps the customer avoid confusion in buying the product after reading through numerous feedbacks. Further, the system and method for reviewing include, but not limited to, a product, a service, a movie, a soap opera, a blog, and a video.

While specific language has been used to describe the disclosure, any limitations arising on account of the same are not intended. As would be apparent to a person skilled in the art, various working modifications may be made to the method in order to implement the inventive concept as taught herein. The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependant on other acts may be performed in parallel with the other acts. The scope of embodiments is by no means limited by these specific examples.

We claim:

1. A system for reviewing a product, comprising:
one or more processors;
a review receiving module operable by the one or more processors, wherein the review receiving module is configured to receive one or more selections of a plurality of positive parameters and a plurality of negative parameters about the product, from one or more users;
a review quotient computing module operable by the one or more processors, wherein the review quotient computing module is configured to:
compute an aggregate value for each of the plurality of positive parameters and each of the plurality of negative parameters using one or more received selections from the review receiving module;
rank the plurality of positive parameters and the plurality of negative parameters based on the aggregate value computed for each of the plurality of positive parameters and each of the plurality of negative parameters;
compute a positive aggregate value and a negative aggregate value based on one or more top-ranked plurality of positive parameters and one or more top-ranked plurality of negative parameters, respectively;
determine a review quotient by computing a ratio between the positive aggregate value and the negative aggregate value;
compare the review quotient determined with a predefined threshold value; and
a recommendation module operable by the one or more processors, wherein the recommendation module is configured to recommend one or more new users to purchase the product based on the review quotient determined.

2. The system as claimed in claim 1, wherein the plurality of positive parameters represents a plurality of positive qualities of the product.

3. The system as claimed in claim 1, wherein the plurality of negative parameters represents a plurality of negative qualities of the product.

4. The system as claimed in claim 1, wherein the one or more selections received from the one or more users are stored in a database hosted in a server.

5. The system as claimed in claim 1, wherein the predefined threshold value is 1.

6. The system as claimed in claim 1, wherein the product is recommended to the one or more new users if the review quotient determined is greater than the predefined threshold value.

7. The system as claimed in claim 1, comprising a verification module operable by the one or more processors, wherein the verification module is configured to prevent the one or more users from selecting different set of the multiple positive parameters and the multiple negative parameters.

8. A method for reviewing a product, comprising:
receiving, by a review receiving module one or more selections of a plurality of positive parameters and a plurality of negative parameters about the product, from one or more users;
computing, by a review quotient computing module, an aggregate value for each of the plurality of positive parameters and each of the plurality of negative parameters using one or more received selections from the review receiving module;
ranking, by the review quotient computing module, the plurality of positive parameters and the plurality of negative parameters based on the aggregate value computed for each of the plurality of positive parameters and each of the plurality of negative parameters;
computing, by the review quotient computing module, a positive aggregate value and a negative aggregate value based on one or more top-ranked plurality of positive parameters and one or more top-ranked plurality of negative parameters, respectively;
determining, by the review quotient computing module, a review quotient by computing a ratio between the positive aggregate value and the negative aggregate value;
comparing, by the review quotient computing module, the review quotient determined with a predefined threshold value; and
recommending, by a recommendation module, the one or more new users to purchase the product based on the review quotient determined.

9. The method as claimed in claim 8, wherein receiving one or more selections from one or more users is stored in a database hosted on a server.

10. The method as claimed in claim 8, wherein recommending, by the recommendation module, the one or more new users to purchase the product based on if the review quotient determined is greater than the predefined threshold.
